(19) United States
(12) Patent Application Publication
(10) Pub. No.: US 2011/0177406 A1
(43) Pub. Date: Jul. 21, 2011

(54) HYDROGEN GENERATION DEVICE AND FUEL CELL

(75) Inventors: Yueh-Chang Wu, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/969,598

(22) Filed: Dec. 16, 2010

(30) Foreign Application Priority Data
Jan. 15, 2010 (CN) 201010002982.X

(51) Int. Cl. H01M 8/06

(52) U.S. Cl. 429/416

(57) ABSTRACT

A hydrogen generation device includes a draft tube, containing grooves, water absorbing structures, capillary structures, and a water supply device. The wall of the draft tube has openings. The containing grooves are disposed below the draft tube and respectively aligned with the openings. Each containing groove is capable of containing a solid fuel. The water absorbing structures are respectively disposed in the containing grooves. Each water absorbing structure is located between the corresponding opening and corresponding solid fuel. The capillary structures are alternatively disposed on the internal wall of the draft tube. Each capillary structure is located between the two adjacent openings. The water supply device is disposed at one end of the draft tube. The water supply device supplies a liquid fuel into the draft tube, and the liquid fuel sequentially enters the containing grooves through the openings to sequentially react with the solid fuels and produce hydrogen.

### CROSS-REFERENCE TO RELATED APPLICATION

This application claims the priority benefit of Chinese application serial no. 201010002982.X, filed on Jan. 15, 2010. The entirety of the above-mentioned patent application is hereby incorporated by reference herein and made a part of this specification.

### BACKGROUND OF THE INVENTION

1. Field of the Invention

The invention generally relates to a hydrogen generation device and a fuel cell with the hydrogen generation device, and more particularly, to a hydrogen generation device using solid fuel and a fuel cell with the hydrogen generation device.

2. Description of Related Art

A fuel cell is an electricity generation apparatus that directly converts chemical energy into electrical energy. Compared to the conventional electricity generation techniques, the fuel cell offers lower pollution, lower noise, higher energy density, and higher energy conversion efficiency, and therefore it is a very promising clean energy source. Fuel cells may be applied in portable electronic products, home electricity generation systems, transportation vehicles, military equipments, the space industry, and small-scale electricity generation systems, etc.

Different fuel cells have different applications according to the operating principles and operating environments. Proton exchange membrane fuel cells (PEMFC) and direct methanol fuel cells (DMFC) are mostly applied to portable power sources. Both PEMFC and DMFC may actuate at low temperature and use proton exchange membranes for conducting protons. According to the operating principle of such a fuel cell, an oxidation reaction for hydrogen is carried out in the anode catalyst layer to produce hydrogen ions H⁺ and electrons e⁻ (the operating principle of PEMFC), or an oxidation reaction for water or methanol is carried out in the anode catalyst layer to produce hydrogen ions H⁺, carbon dioxide (CO₂), and electrons e⁻ (the operating principle of DMFC), wherein the hydrogen ions H⁺ are conducted by the proton exchange membrane to the cathode, while the electrons e⁻ are transmitted by an external circuit to the load before they are conducted to the cathode. Herein a redox reaction between the oxygen supplied to the cathode and the hydrogen ions H⁺ and electrons e⁻ is carried out in the cathode catalyst layer and water is produced. The hydrogen supplied to the anode may be obtained through a solid NaBH₄ hydrogen storage technique, wherein water is added into solid NaBH₄, and the two react with each other to produce hydrogen.

U.S. Pat. No. 6,746,496, U.S. Pat. No. 7,306,780, and U.S. Pat. No. 7,427,302 respectively disclose related techniques.

The reaction between solid NaBH₄ and water is a one-off reaction, and once the reaction starts, it won't stop until the solid NaBH₄ or water completely runs out. Thereby, the problem of how to carry out the reaction in multiple stages has to be resolved.

### SUMMARY OF THE INVENTION

Accordingly, the invention is directed to a hydrogen generation device, wherein the reaction between a solid fuel and water is carried out in multiple stages.

The invention is directed to a fuel cell, wherein the reaction between a solid fuel and water is carried out in multiple stages in a hydrogen generation device of the fuel cell.

Additional aspects and advantages of the invention may be further understood from the description that follows.

According to an embodiment of the invention, a hydrogen generation device adapted to a fuel cell is provided. The hydrogen generation device includes a draft tube, a plurality of containing grooves, a plurality of water absorbing structures, a plurality of capillary structures, and a water supply device. The wall of the draft tube has a plurality of openings. The containing grooves are disposed below the draft tube and respectively aligned with the openings, wherein each of the containing grooves is capable of containing a solid fuel. The water absorbing structures are respectively disposed in the containing grooves, wherein each of the water absorbing structures is located between the corresponding opening and the corresponding solid fuel. The capillary structures are alternatively disposed on the internal wall of the draft tube, wherein each of the capillary structures is located between the two adjacent openings. The water supply device is disposed at one end of the draft tube. The water supply device is capable of supplying a liquid fuel into the draft tube, and the liquid fuel is capable of sequentially entering the containing grooves through the openings to sequentially react with the solid fuels and produce hydrogen.

According to an embodiment of the invention, a fuel cell including a hydrogen generation device, a fuel cell stack, and a guiding structure is provided. The hydrogen generation device includes a draft tube, a plurality of containing grooves, a plurality of water absorbing structures, a plurality of capillary structures, and a water supply device. The wall of the draft tube has a plurality of openings. The containing grooves are disposed below the draft tube and respectively aligned with the openings, wherein each of the containing grooves is capable of containing a solid fuel. The water absorbing structures are respectively disposed in the containing grooves, wherein each of the water absorbing structures is located between the corresponding opening and the corresponding solid fuel. The capillary structures are alternatively disposed on the internal wall of the draft tube, wherein each of the capillary structures is located between the two adjacent openings. The water supply device is disposed at one end of the draft tube. The water supply device is capable of supplying a liquid fuel into the draft tube, and the liquid fuel is capable of sequentially entering the containing grooves through the openings to sequentially react with the solid fuels and produce hydrogen. The guiding structure is connected between the hydrogen generation device and the fuel cell stack and capable of guiding the hydrogen produced by the reaction between the solid fuels and the liquid fuel to the fuel cell stack.

As described above, embodiments of the invention have at least one of following advantages. Instead of reacting with the solid fuels in all the containing grooves at the same time, the liquid fuel supplied by the water supply device sequentially enters the containing grooves and sequentially reacts with the solid fuels in the containing grooves to produce hydrogen. Thus, a user may control the solid fuels to sequentially react with the liquid fuel continuously or stop the liquid fuel from running in the draft tube (so that some solid fuels do not react with the liquid fuel) by turning on/off the water supply device or adjusting the water supply power of the water supply device, so as to achieve a staged reaction. In addition, the water absorbing structures disposed between the openings and the solid fuels allow the liquid fuel to slowly enter the containing grooves and steadily react with the solid fuels, and the water absorbing structures also prevent the water solution produced by the reaction between the solid fuels and the liquid fuel from entering the draft tube. Moreover, the capillary structure disposed between the two adjacent openings buffers the running liquid fuel so that the liquid fuel is prevented from entering another containing groove before it has completely reacted with the solid fuel in the current containing groove.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a hydrogen generation device according to an embodiment of the invention.

FIG. 2 is a diagram illustrating a reaction of a liquid fuel with some solid fuels in FIG. 1.

FIG. 3 is a diagram of a hydrogen generation device according to another embodiment of the invention.

FIG. 4 is a diagram of a hydrogen generation device according to yet another embodiment of the invention.

FIG. 5 is a diagram illustrating a cover covering an opening in FIG. 4.

FIG. 6 is a diagram of a fuel cell with the hydrogen generation device in FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

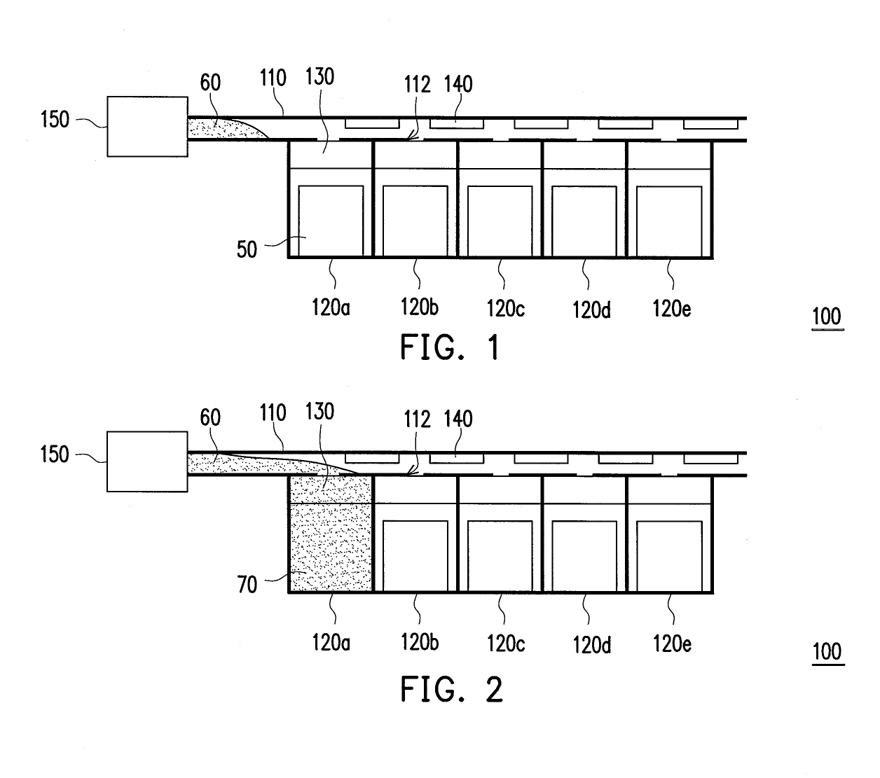

FIG. 1 is a diagram of a hydrogen generation device according to an embodiment of the invention. Referring to FIG. 1, the hydrogen generation device 100 in the embodiment is adapted to a fuel cell for supplying hydrogen required by the reaction at the anode of the fuel cell. The hydrogen generation device 100 includes a draft tube 110, a plurality of containing grooves 120a-120e, a plurality of water absorbing structures 130, a plurality of capillary structures 140, and a water supply device 150. In the embodiment, there are five containing grooves 120a-120e. However, the invention is not limited thereto, and the number of containing grooves depends on the request.

The wall of the draft tube 110 has a plurality of openings 112. The containing grooves 120a-120e are disposed below the draft tube 110 and respectively aligned with the openings 112, wherein each of the containing grooves 120a-120e is capable of containing a solid fuel 50. In the embodiment, the solid fuel 50 may be solid NaBH₄. However, the invention is not limited thereto, and the solid fuel 50 may also be other types of solid fuels. The water absorbing structures 130 are respectively disposed in the containing grooves 120a-120e, wherein each of the water absorbing structures 130 is located between the corresponding opening 112 and the corresponding solid fuel 50. The capillary structures 140 are alternatively disposed on the internal wall of the draft tube 110, wherein each of the capillary structures 140 is located between two adjacent openings 112. The water supply device 150 is disposed at one end of the draft tube 110.

FIG. 2 is a diagram illustrating a reaction of a liquid fuel reacts with some solid fuels in FIG. 1. Referring to FIG. 1, through the dispositions described above, a user may supply a liquid fuel 60 (for example, liquid water) into the draft tube 110 through the water supply device 150 so that the liquid fuel 60 sequentially enters the containing grooves 120a-120e through the openings 112 and reacts with the solid fuels 50 to produce hydrogen. To be specific, referring to FIG. 2, the liquid fuel 60 enters the containing groove 120a through the first opening 112 and the corresponding water absorbing structure 130 and reacts with the solid fuel 50 in the containing groove 120a to produce a water solution 70 and hydrogen, wherein the water solution 70 is NaBO₂.H₂O or NaBO₂.4H₂O when the solid fuel 50 is solid NaBH₄. If the user wants to stop the hydrogen generation device 100 from supplying hydrogen, the user turns off the water supply device 150 so that the solid fuels 50 in the containing grooves 120b-120e do not react with the liquid fuel 60. Thereby, a staged reaction is achieved.

On the other hand, if the user wants the hydrogen generation device 100 to continue supplying hydrogen after the solid fuel 50 in the containing groove 120a has completely reacted with the liquid fuel 60, the user controls the water supply device 150 to continue supplying liquid fuel 60 so that the liquid fuel 60 flows along the draft tube 110 and enters the containing groove 120b through the next opening 112 to react with the solid fuel 50 in the containing groove 120b and produce hydrogen. Similarly, the liquid fuel 60 is further controlled to sequentially enter the containing groove 120c, the containing groove 120d, and the containing groove 120e to react with the solid fuels 50 therein and produce hydrogen. By this way, the user may control the solid fuels 50 to react with the liquid fuel 60 sequentially and continuously or stop the liquid fuel 60 from running in the draft tube 110 (so that some solid fuels 50 do not react with the liquid fuel 60) by turning on/off the water supply device 150 or adjusting the water supply power of the water supply device 150. Thereby, a staged reaction is achieved. It should be noted that the reaction efficiency is also increased by respectively placing the solid fuels 50 in the containing grooves 120a-120e to respectively react with the liquid fuel 60.

To be specific, the water absorbing structures 130 disposed between the openings 112 and the solid fuels 50 allow the liquid fuel 60 to slowly enter the containing grooves 120a-120e and steadily react with the solid fuels 50, which also prevent the water solution produced by the reaction between the solid fuels 50 and the liquid fuel 60 from entering the draft tube 110 or contaminating the liquid fuel 60 in the draft tube 110. In addition, the capillary structure 140 disposed between every two adjacent openings 112 buffers the running liquid fuel 60 so that the liquid fuel 60 is prevented from entering another containing groove (for example, the containing groove 120b) before it has completely reacted with the solid fuel 50 in the current containing groove (for example, the containing groove 120a). It should be noted that these capillary structures 140 are alternatively disposed so that the liquid fuel 60 is prevented from being conducted from one capillary structure 140 to another capillary structure 140. Moreover, the water supply device 150 in the embodiment may be a water pump. The water pump provides power with different levels to the hydrogen generation device 100 of the embodiment, such that it is more precise to control the range where the liquid fuel 60 flows to in the draft tube 110.

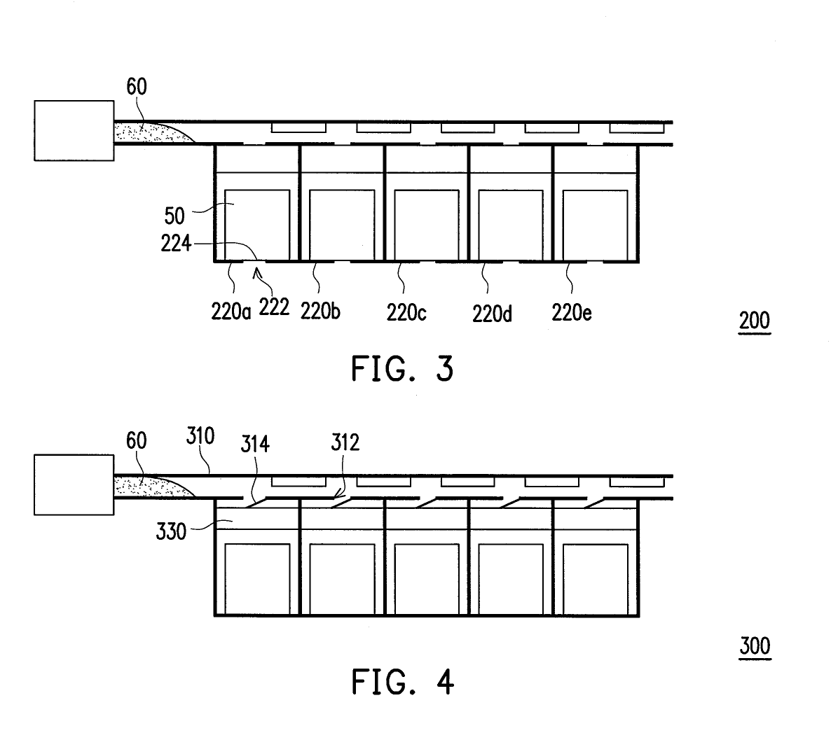

The water absorbing structures 130 in the embodiment may be porous structures. The hydrogen produced by the reaction between the solid fuels 50 and the liquid fuel 60 is exhausted from the containing grooves 120a-120e through the water absorbing structures 130 and the openings 112 and conducted to the anode of the fuel cell. However, approaches for exhausting the hydrogen are not limited in the invention, and in other embodiments, the hydrogen may also be exhausted through other methods, as the one described below with reference to FIG. 3.

FIG. 3 is a diagram of a hydrogen generation device according to another embodiment of the invention. Referring to FIG. 3, in the embodiment, each of the containing grooves 220a-220e of the hydrogen generation device 200 has a hole 222 and a waterproof breathable membrane 224 for covering the hole 222. Thus, the hydrogen produced by the reaction between the solid fuels 50 and the liquid fuel 60 is exhausted from the containing grooves 220a-220e through the waterproof breathable membranes 224, while the water solution produced by the reaction between the solid fuels 50 and the liquid fuel 60 is blocked by the waterproof breathable membranes 224 without leaking out.

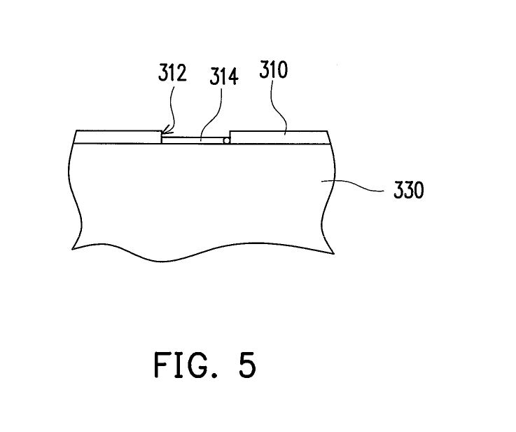

FIG. 4 is a diagram of a hydrogen generation device according to yet another embodiment of the invention. FIG. 5 is a diagram illustrating a cover covering an opening in FIG. 4. Referring to FIG. 4, in the hydrogen generation device 300 of the embodiment, the draft tube 310 has a plurality of covers 314. The covers 314 are respectively pivoted beside the openings 312, and the water absorbing structures 330 are capable of absorbing the liquid fuel 60 to expand and push the covers 314 to cover the openings 312 (as shown in FIG. 5). Through the dispositions described above, after the water absorbing structures 330 absorb enough liquid fuel 60, the covers 314 are pushed by the expanded water absorbing structures 330 to seal the openings 312, so that the liquid fuel 60 is prevented from entering the containing groove with enough liquid fuel 60 and directly flows towards the next containing groove.

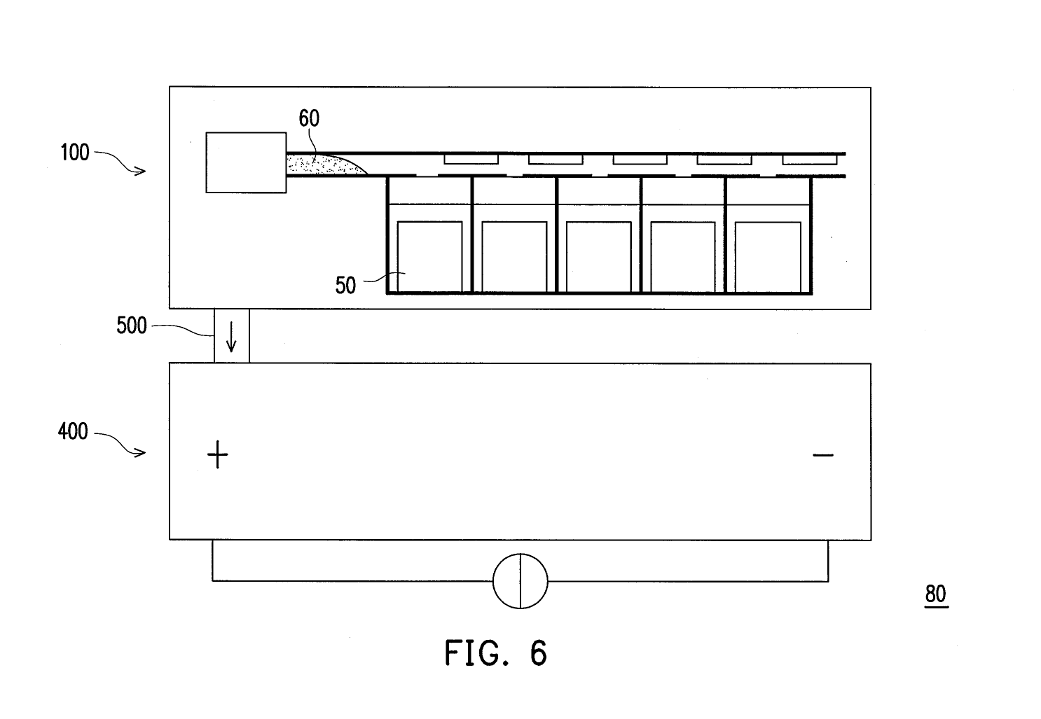

The hydrogen generation device of embodiments described above may be applied to a fuel cell for supplying hydrogen required by the reaction at the anode of the fuel cell. The application of the hydrogen generation device 100 in FIG. 1 will be described as an example. FIG. 6 is a diagram illustrating a fuel cell with the hydrogen generation device in FIG. 1. Referring to FIG. 6, the fuel cell 80 in the embodiment is composed of the hydrogen generation device 100 illustrated in FIG. 1, a fuel cell stack 400, and a guiding structure 500. The guiding structure 500 is connected between the hydrogen generation device 100 and the fuel cell stack 400 and capable of guiding the hydrogen produced by the reaction between the solid fuels 50 and the liquid fuel 60 to the fuel cell stack 400 to be used by the reaction at the anode of the fuel cell stack 400. It should be noted that the oxygen required by the reaction at the cathode of the fuel cell stack 400 may be supplied by another supply source, and this other supply source is not illustrated in the embodiment. The fuel cell 80 in the embodiment may be applied to an electronic device (for example, a notebook computer or a cell phone) or a transportation vehicle (for example, a car or a boat).

As described above, embodiments of the invention have at least one of following advantages. Instead of reacting with the solid fuels in all the containing grooves at the same time, the liquid fuel supplied by the water supply device sequentially enters the containing grooves and sequentially reacts with the solid fuels in the containing grooves to produce hydrogen. Thus, a user may control the solid fuels to sequentially react with the liquid fuel continuously or stop the liquid fuel from running in the draft tube (so that some solid fuels do not react with the liquid fuel) by turning on/off the water supply device or adjusting the water supply power of the water supply device, so as to achieve a staged reaction. In addition, the water absorbing structures disposed between the openings and the solid fuels allow the liquid fuel to slowly enter the containing grooves and steadily react with the solid fuels, and the water absorbing structures also prevent the water solution produced by the reaction between the solid fuels and the liquid fuel from entering the draft tube. Moreover, the capillary structure disposed between the two adjacent openings buffers the running liquid fuel so that the liquid fuel is prevented from entering another containing groove before it has completely reacted with the solid fuel in the current containing groove.

Additionally, the water absorbing structures may be porous structures such that the hydrogen produced by the reaction between the solid fuels and the liquid fuel may be exhausted through the water absorbing structures. Moreover, holes and waterproof breathable membranes for covering the holes may be further disposed in the containing grooves such that the hydrogen may be exhausted through the waterproof breathable membranes. Furthermore, covers may be disposed beside the openings, and the covers are pushed by the expanded water absorbing structures to seal the openings, so that the liquid fuel is prevented from entering the containing groove containing enough liquid fuel and directly flows towards the next containing groove.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A hydrogen generation device, adapted to a fuel cell, the hydrogen generation device comprising:
a draft tube, wherein a wall of the draft tube has a plurality of openings;
a plurality of containing grooves, disposed below the draft tube and respectively aligned with the openings, wherein each of the containing grooves is capable of containing a solid fuel;
a plurality of water absorbing structures, respectively disposed in the containing grooves, wherein each of the water absorbing structures is located between the corresponding opening and the corresponding solid fuel;
a plurality of capillary structures, alternatively disposed on an internal wall of the draft tube, wherein each of the capillary structures is located between the two adjacent openings; and
a water supply device, disposed at one end of the draft tube, wherein the water supply device is capable of supplying a liquid fuel into the draft tube, and the liquid fuel is capable of sequentially entering the containing grooves through the openings to sequentially react with the solid fuels and produce hydrogen.

2. The hydrogen generation device according to claim 1, wherein the water supply device is a water pump.

3. The hydrogen generation device according to claim 1, wherein each of the containing grooves has a cover, the cover is pivoted beside the corresponding opening, and the corresponding water absorbing structure is capable of absorbing the liquid fuel to expand and push the cover for covering the opening.

4. The hydrogen generation device according to claim 1, wherein the draft tube has a plurality of covers, the covers are respectively pivoted beside the openings, and each of the water absorbing structures is capable of absorbing the liquid fuel to expand and push the corresponding cover for covering the corresponding opening.

5. The hydrogen generation device according to claim 1, wherein the water absorbing structures are porous structures, and the hydrogen produced by a reaction between the solid fuels and the liquid fuel is capable of being exhausted from the containing grooves through the water absorbing structures and the openings.

6. A fuel cell, comprising:
a hydrogen generation device, comprising:
a draft tube, wherein a wall of the draft tube has a plurality of openings;
a plurality of containing grooves, disposed below the draft tube and respectively aligned with the openings, wherein each of the containing grooves is capable of containing a solid fuel;
a plurality of water absorbing structures, respectively disposed in the containing grooves, wherein each of the water absorbing structures is located between the corresponding opening and the corresponding solid fuel;
a plurality of capillary structures, alternatively disposed on an internal wall of the draft tube, wherein each of the capillary structures is located between the two adjacent openings;
a water supply device, disposed at one end of the draft tube, wherein the water supply device is capable of supplying a liquid fuel into the draft tube, and the liquid fuel is capable of sequentially entering the containing grooves through the openings to sequentially react with the solid fuels and produce hydrogen;
a fuel cell stack; and
a guiding structure, connected between the hydrogen generation device and the fuel cell stack, wherein the guiding structure is capable of guiding the hydrogen produced by a reaction between the solid fuels and the liquid fuel to the fuel cell stack.

7. The fuel cell according to claim 6, wherein the water supply device is a water pump.

8. The fuel cell according to claim 6, wherein the draft tube has a plurality of covers, the covers are respectively pivoted beside the openings, and each of the water absorbing structures is capable of absorbing the liquid fuel to expand and push the corresponding cover to cover the corresponding opening.

9. The fuel cell according to claim 6, wherein each of the containing grooves has a hole and a waterproof breathable membrane covering the hole, and the hydrogen produced by the reaction between the solid fuels and the liquid fuel is capable of being exhausted from the containing groove through the waterproof breathable membrane.

10. The fuel cell according to claim 6, wherein the water absorbing structures are porous structures, and the hydrogen produced by the reaction between the solid fuels and the liquid fuel is capable of being exhausted from the containing grooves through the water absorbing structures and the openings.
